(19) United States
(12) Patent Application Publication
(10) Pub. No.: US 2021/0234195 A1
(43) Pub. Date: Jul. 29, 2021

(54) LITHIUM SECONDARY BATTERY EMPLOYING GEL-TYPE POLYMER ELECTROLYTE AND MANUFACTURING METHOD THEREFOR

(71) Applicant: GRINERGY CO.LTD., Seoul (KR)

(72) Inventor: Myung Dong Cho, Hwaseong-si, Gyeonggi-do (KR)

(21) Appl. No.: 17/254,452

(22) PCT Filed: Jun. 22, 2018
(86) PCT No.: PCT/KR2018/007075

§ 371 Date: Apr. 9, 2021

(51) Int. Cl. H01M 10/0565; H01M 10/0525; H01M 4/485; H01M 10/04

(52) U.S. Cl. CPC H01M 10/0565; H01M 10/0525; H01M 2004/027; H01M 10/04; H01M 2300/0025; H01M 4/485

(57) ABSTRACT

Provided are a lithium secondary battery including a gel-type polymer electrolyte and a manufacturing method thereof. The lithium secondary battery includes a gel-type polymer electrolyte, which fills pores of an anode and a cathode in a state in which a crosslinkable monomer is crosslinked, and may thus inhibit an electrochemical side reaction and an electrolyte decomposition reaction, which occur in the anode and the cathode, thereby securing the improvement of battery characteristics and the stability of battery. The application of the gel-type polymer electrolyte makes it possible to easily manufacture, especially, a lithium secondary battery usable at a high voltage employing an LTO anode.

### TECHNICAL FIELD

The present disclosure relates to a lithium secondary battery and a manufacturing method thereof, and more specifically, to a lithium secondary battery based on an LTO anode to which a gel-type polymer electrolyte is applied and a manufacturing method thereof.

### BACKGROUND ART

Lithium secondary batteries which have recently drawn attention as power sources for various electronic devices use organic electrolytes, and thus have twice or more the discharge voltage than existing batteries using alkali aqueous solutions, thereby having high energy density.

The existing lithium secondary batteries include a cathode and an anode provided with an active material reversibly absorbing and desorbing lithium ions, a separator electrically separating the cathode and the anode, and an electrolyte between the cathode and the anode, and performs charging/discharging by lithium ions traveling between the two electrodes. In this case, due to a change in crystal structure of the electrodes during the charging/discharging, an electrode plate may expand or contract, or increase in thickness and volume during the charging/discharging, and as a result, a microstructure formed by an active material, a binder, a conductive agent, etc. of the electrode plate may be cracked or delaminated.

A lithium titanium oxide (LTO) electrode has a 3D spinel structure, and is not limited in intercalation/deintercalation of lithium ions, thereby having excellent charging characteristics compared to one-dimensional interlayer intercalation of general graphite.

However, lithium secondary batteries using LTO as an anode have fairly lower voltage characteristics than existing lithium secondary batteries using graphite as an anode. Among single cell batteries in which an LTO anode is combined with various types of cathodes, for example, a single cell battery in which an LCO cathode is combined with an LTO anode has an average voltage of about 2.4 V, and a single cell battery in which an NMC cathode is combined with an LTO anode has an average of about 2.3 V. On the other hand, among single cell batteries in which a general graphite anode using graphite is combined with various types of cathodes, for example, a single cell battery in which an LCO cathode is combined with a graphite anode has an average voltage of about 3.8 V, and a single cell battery in which an NMC cathode is combined with a graphite anode has an average voltage of about 3.7 V.

In an effort to overcome the limitation described above, research has been conducted to increase the voltage through serial connection of internal unit cells. However, when the voltage increases due to the series structure, electrochemical side reactions and electrolyte solution decomposition reactions that occur in the cathode and the anode are more likely to happen, thereby causing side effects such as deterioration of battery characteristics. Given the fact that the issues above are targeted to be resolved, it is worthwhile to consider a new type of liquid electrolyte or electrolyte at this point in time.

In this regard, development of lithium secondary batteries capable of inhibiting the electrolyte decomposition reactions and improving charging and voltage characteristics is needed.

### DESCRIPTION OF EMBODIMENTS

### Technical Problem

Provided is a lithium secondary battery capable of inhibiting an electrolyte reaction and minimizing a decomposition reaction.

Provided is a method of manufacturing the lithium secondary battery.

### Solution to Problem

According to an aspect of the present disclosure, there is a provided a lithium secondary battery including a unit cell containing:

a cathode including a cathode active material layer disposed on a cathode current collector;

an anode including an anode active material layer disposed on an anode current collector; and

a separator disposed between the cathode and the anode,

wherein at least one of the anode active material layer and the cathode active material layer is porous, and the lithium secondary battery further includes a gel-type polymer electrolyte, which fills the pores thereof in a state in which a crosslinkable monomer is crosslinked.

According to another aspect of the present disclosure, there is a provided a method of manufacturing a lithium secondary battery, the method including:

preparing a unit cell including a cathode containing a cathode active material layer disposed on a cathode current collector, an anode including an anode active material layer disposed on an anode current collector, and a separator disposed between the cathode and the anode;

immersing the unit cell into a gel precursor solution containing a crosslinkable monomer and an organic electrolyte; and

curing the gel precursor solution to obtain a lithium secondary battery containing a gel-type polymer electrolyte.

### Advantageous Effects of Disclosure

The lithium secondary battery includes a gel-type polymer electrolyte, which fills pores of an anode and a cathode in a state in which a crosslinkable monomer is crosslinked, and thus may have no leakage in a state in which a liquid electrolyte is wet-trapped in a polymer matrix of the gel-type polymer electrolyte, and inhibit an electrochemical side reaction and an electrolyte decomposition reaction, which occur in the anode and the cathode, thereby securing the improvement of battery characteristics and the stability of battery.

### BRIEF DESCRIPTION OF THE DRAWINGS

FIG. 1 is a schematic view showing a unit cell structure of a lithium secondary battery according to an embodiment.

FIG. 2 is a schematic view showing a manufacturing method of a lithium secondary battery using a gel precursor solution according to an embodiment.

FIG. 3 is a graph showing results of evaluation of high-temperature discharge characteristics of lithium secondary batteries prepared in Example 1 and Comparative Example 1 at 60° C. and 80° C.

FIG. 4 is a graph showing results of evaluation of swelling characteristics of lithium secondary batteries prepared in Example 1 and Comparative Example 1.

### MODE OF DISCLOSURE

The present inventive concept described below may be modified in various forms and have many embodiments, and particular embodiments are illustrated in the drawings and described in detail in the detailed description. However, the present inventive concept should not be construed as limited to the particular embodiments, but should be understood to cover all modifications, equivalents or replacements included in the technical scope of the present inventive concept.

The terminology used herein is for the purpose of explaining particular embodiments only and is not intended to limit the present inventive concept. The singular forms include the plural forms as well, unless the context clearly indicates otherwise. It will be further understood that the terms “comprise” or “comprising” when used herein, specify the presence of stated features, numbers, steps, operations, elements, parts, components, materials, or combinations thereof, but do not preclude the presence or addition of one or more other features, numbers, steps, operations, elements, parts, components, materials, or combinations thereof. “I” used hereinafter may be interpreted as “and” or interpreted as “or” according to circumstances.

In the drawings, the diameter, length, and thicknesses of elements, layers and regions are enlarged or reduced for clear explanation. The same reference numerals are designated for similar elements throughout. When a layer, film, region, plate, or the like is referred to as being “on” another part, it can be directly on the other part, or intervening parts may be present. The terms “first”, “second”, and the like may be used for describing various elements throughout, but the elements are not limited by the terms. The terms are used to only distinguish one element from other elements. Some of elements may be omitted in the drawings, but this is for aiding understanding of the features of the present disclosure, and is not intended to exclude the omitted elements.

Hereinafter, an example lithium secondary battery and a manufacturing method thereof will be described in detail with reference to the accompanying drawings.

A lithium secondary battery according to an embodiment includes:

a cathode including a cathode active material layer disposed on a cathode current collector;

an anode including an anode active material layer disposed on an anode current collector; and

a separator disposed between the cathode and the anode,

wherein at least one of the anode active material layer and the cathode active material layer is porous, and the lithium secondary battery further includes a gel-type polymer electrolyte, which fills the pores thereof in a state in which a crosslinkable monomer is crosslinked.

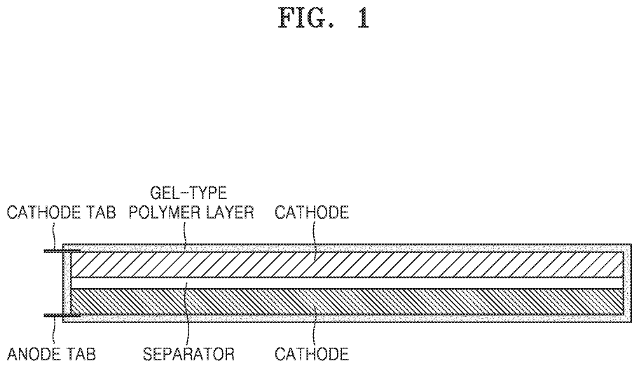

FIG. 1 is a schematic view showing a unit cell structure of a lithium secondary battery according to an embodiment.

An anode includes an anode active material layer disposed on an anode current collector, and for example, an anode active material composition mixed with an anode active material, a binder, and optionally a conductive agent and a solvent is prepared, and then the composition may be molded to have a predetermined shape or applied to an anode current collector such as copper foil to form an anode.

Any anode active materials of lithium secondary batteries used in the art may be used as an anode active material used in the anode active material layer. As non-limiting examples of the anode active material layer, lithium metal, a metal alloyable with lithium, transition metal oxide, a material capable of doping and dedoping lithium, a material capable of reversibly intercalating and deintercalating lithium ions, etc. may be used, and also two or more of a mixture or combination thereof may be used.

Non-limiting examples of the transition metal oxide may include tungsten oxide, molybdenum oxide, titanium oxide, lithium titanium oxide, vanadium oxide, lithium vanadium oxide, etc.

The materials capable of doping and dedoping lithium may be, for example, Si, SiOₓ (where 0<x≤2), Si—Y alloy (where Y is an alkali metal, alkaline earth metal, Group 13 element, Group 14 element, Group 15 element, Group 16 element, transition metal, rare earth element, or a combination element thereof, but not Si), and Sn, SnO₂, Sn—Y alloy (where the Y is an alkali metal, alkaline earth metal, Group 13 element, Group 14 element, transition metal, rare earth element, or a combination element thereof, but not Sn), and at least one of the materials and SiO₂ may be mixed and used. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

As a material capable of reversibly intercalating and deintercalating lithium ions, any carbon-based anode active materials generally used in lithium batteries may be used. For example, the materials may be crystalline carbon, amorphous carbon or a mixture thereof. Non-limiting examples of the crystalline carbon include shapeless, plate, flake, circular, or fiber types of natural graphite or artificial graphite. Non-limiting examples of the amorphous carbon include soft carbon (low temperature baked carbon) or hard carbon, mesophase pitch carbides, and baked coke.

According to an embodiment, as the anode active material, an active material capable of achieving high capacity, such as a silicon-based active material such as Si, SiOₓ (where 0<x≤2), and Si—Y alloy, a tin-based active material such as Sn, SnO₂, and Sn—Y alloy, a silicon-tin alloy-based active material, or a silicon-carbon-based active material may be used. Accordingly, the active material capable of achieving high capacity as described above may prevent the active material from being separated by a water-soluble binder bonded between the active materials even when the active material expands or contracts due to charging/discharging, and keep an electron transfer path in an electrode, thereby improving the rate characteristics of lithium batteries.

According to an embodiment, the anode active material layer may contain lithium titanium oxide (LTO). LTO has a 3D spinel structure, and is not limited in intercalation/deintercalation of lithium ions, thereby having excellent charging characteristics compared to one-dimensional interlayer intercalation of general graphite. When the anode active material layer containing LTO is applied, a lithium secondary battery usable at a high voltage may be provided.

The anode active material may be in the form of simple particles, and may have a nano-sized nanostructure. For example, the anode active material may have various forms such as nanoparticles, nanowires, nanorods, nanotubes, and nanobelts.

The binder well bonds the anode active material particles to each other, and also serves to bond the anode active material to a current collector well, and representative examples thereof are polyvinyl alcohol, carboxymethyl cellulose, hydroxypropyl cellulose, polyvinyl chloride, carboxylated polyvinyl chloride, polyvinyl fluoride, polymer containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, etc., but are not limited thereto.

The binder may be added in an amount of 1 part by weight to 20 parts by weight or, for example, 2 parts by weight to 10 parts by weight, with respect to 100 parts by weight of the anode active material.

The conductive agent is used to impart conductivity to an electrode, and any materials used as an electronic conductive material without causing chemical changes in batteries may be used, and for example, carbon-based materials such as natural graphite, artificial graphite, carbon black, acetylene black, ketjen black, and carbon fiber; metallic materials such as copper, nickel, aluminum, and silver in the form of metal power or metal fiber; conductive polymers such as polyphenylene derivatives; or a mixture thereof may be used. The content of the conductive material may be properly controlled to be used.

As a solvent, N-methylpyrrolidone (NMP), acetone, water, etc. may be used, but the embodiment is not limited thereto. The solvent is contained in an amount of 10 parts by weight to 300 parts by weight with respect to 100 parts by weight of the anode active material. When the solvent is contained in the above ranges, a process for forming the active material layer gets easy.

Depending on the usage and configuration of the lithium secondary battery, at least one of the conductive agent, the binder, and the solvent may be omitted when the anode active material layer is prepared.

An anode current collector is generally formed to have a thickness of about 3 μm to about 500 μm. The anode current collector is not particularly limited as long as it has conductivity without causing chemical changes in the battery, and for example, copper, stainless steel, aluminum, nickel, titanium, baked carbon, or copper or stainless steel that is surface-treated with carbon, nickel, titanium, silver, etc. may be used. Fine irregularities may be formed on a surface of the anode current collector to increase the adhesion of the anode active material, and the anode current collector may have various forms such as a film, a sheet, a foil, a net, a porous body, a foam body, and a non-woven fabric body.

The prepared anode active material composition may be directly applied onto the anode current collector to obtain an anode plate, or an anode active material layer cast on a separate support and delaminated from the support may be laminated on the anode current collector to obtain an anode plate. The anode is not limited to the forms listed above, but may have forms other than the above forms.

The anode active material layer prepared as described above may be porous.

The lithium secondary electrode may further include a gel-type polymer electrolyte, which fills the pores formed on the anode active material layer in a state in which a crosslinkable monomer is crosslinked. Descriptions thereof will be illustrated later.

A cathode includes a cathode active material layer disposed on a cathode current collector, and for example, a cathode active material composition mixed with a cathode active material, a binder, and optionally a conductive agent and a solvent is prepared, and then the composition may be molded to have a predetermined shape or applied to the cathode current collector to form a cathode.

Any cathode active materials of a lithium secondary electrode used in the art may be used as a cathode active material. The cathode active materials may be, for example, a compound represented by one of the following formulae: LiₐA_{1-b}B_{b}D₂ (where 0.90≤a≤1 and 0≤b≤0.5); LiₐE_{1-b}B_{b}O_{2-c}D_{c} (where 0.90≤a≤1, 0≤b≤0.5, and 0≤c≤0.05); LiE_{2-b}B_{b}O_{4-c}D_{c} (where 0≤b≤0.5 and 0≤c≤0.05); LiₐNi_{1-b-c}Co_{b}B_{c}D_{α} (where 0.90≤a≤1, 0≤b≤0.5, 0≤c≤0.05, and 0<α≤2); LiₐNi_{1-b-c}Co_{b}B_{c}O_{2-α}F_{α} (where 0.90≤a≤1, 0≤b≤0.5, 0≤c≤0.05, and 0<α<2); LiₐNi_{1-b-c}Co_{b}B_{c}O_{2-α}F₂ (where 0.90≤a≤1, 0≤b≤0.5, 0≤c≤0.05, and 0<α<2); LiₐNi_{1-b-c}Mn_{b}B_{c}D_{α} (where 0.90≤a≤1, 0≤b≤0.5, 0≤c≤0.05, and 0<α≤2); LiₐNi_{1-b-c}Mn_{b}B_{c}O_{2-α}F_{α} (where 0.90≤a≤1, 0≤b≤0.5, 0≤c≤0.05, and 0<α<2); LiₐNi_{1-b-c}Mn_{b}B_{c}O_{2-α}F₂ (where 0.90≤a≤1, 0≤b≤0.5, 0≤c≤0.05, and 0<α<2); LiₐNi_{b}E_{c}G_{d}O₂ (where 0.90≤a≤1, 0≤b≤0.9, 0≤c≤0.5, and 0.001≤d≤0.1); LiₐNi_{b}Co_{c}Mn_{d}GₑO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); LiₐMnG_{b}O₂ (where 0.90≤a≤1 and 0.001≤b≤0.10); LiₐMn₂G_{b}O₄ (where 0.90≤a≤1 and 0.001≤b≤0.1); QO₂; QS₂; LiQS₂; V₂O₅; LiV₂O₅; LiIO₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

A compound to which a coating layer is added to a surface of the compound may be used, and a mixture of the compound and a compound to which a coating layer is added may be used. The coating layer may include coating element compounds such as an oxide of a coating element, a hydroxide, an oxyhydroxide of a coating element, an oxycarbonate of a coating element, or a hydroxycarbonate of a coating element. The compounds forming the coating layer may be amorphous or crystalline. The coating element included in the coating layer may be Mg, Al, Co, K, Na, Ca, Si, Ti, V, Sn, Ge, Ga, B, As, Zr, or a mixture thereof. The forming of the coating layer may be performed through any methods (e.g., spray coating, dipping, etc.) that do not adversely affect the physical properties of the cathode active material, using the elements in the compounds, and the coating methods may be well understood by one of ordinary skill in the art, and thus a detailed description thereof will be omitted.

For example, as a cathode active material, LLiNiO₂, LiCoO₂, LiMnₓO₂ₓ (where x=1, 2), LiNi₁₋ₓMnₓO₂ (where 0<x<1), LiNi_{1-x-y}CoₓMn_{y}O₂ (where 0≤x≤0.5 and 0≤y≤0.5), Li_{(3-f)}Fe₂(PO₄)₃ (where 0≤f≤2); LiFePO₄, LiFeO₂, V₂O₅, TiS, MoS, etc. may be used.

The binder well bonds the cathode active material particles to each other, and also serves to bond the cathode active material to the cathode current collector well, and specific examples thereof are polyvinyl alcohol, carboxymethyl cellulose, hydroxypropyl cellulose, diacetyl cellulose, livinyl chloride, carboxylated polyvinyl chloride, polyvinyl fluoride, polymer containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, etc. but are not limited thereto.

The conductive agent is used to impart conductivity to an electrode, and any materials used as an electronic conductive material without causing chemical changes in a battery may be used, and for example, natural graphite, artificial graphite, carbon black, acetylene black, ketjen black, carbon fiber, and metal power or metal fiber such as copper, nickel, aluminum, and silver may be used, and also conductive materials such as polyphenylene derivatives may be used alone or in combination of one or more.

In the cathode active material composition, the conductive agent, the binder, and the solvent may be the same as those of the negative electrode active material composition described above. In some cases, pores may be formed inside the electrode plate by adding a plasticizer to the cathode active material composition and the anode active material composition. The cathode active material, the conductive agent, the binder, and the solvent are contained in an amount commonly used in lithium secondary batteries.

Depending on the usage and configuration of the lithium secondary battery, at least one of the conductive agent, the binder, and the solvent may be omitted when the cathode active material layer is prepared.

A cathode current collector is generally formed to have a thickness of about 3 μm to about 500 μm. The cathode current collector is not particularly limited as long as it has conductivity without causing chemical changes in the battery, and for example, copper, stainless steel, aluminum, nickel, titanium, baked carbon, or copper or stainless steel that is surface-treated with carbon, nickel, titanium, silver, etc. may be used. In addition, fine irregularities may be formed on a surface of the cathode current collector to increase the adhesion of the cathode active material, and the cathode current collector may have various forms such as a film, a sheet, a foil, a net, a porous body, a foam body, and a non-woven fabric body.

The prepared cathode active material composition may be directly applied onto the cathode current collector to obtain a cathode, or a cathode active material layer cast on a separate support and delaminated from the support may be laminated on the cathode current collector to obtain a cathode. The cathode is not limited to the forms listed above, but may have forms other than the above forms.

The cathode active material layer prepared as described above may be porous.

The lithium secondary electrode may further include a gel-type polymer electrolyte, which fills the pores formed on the cathode active material layer in a state in which a crosslinkable monomer is crosslinked. Descriptions thereof will be illustrated later.

The cathode and the anode may be separated by a separator, and any separators commonly used in lithium secondary batteries may be used. In particular, separators having low resistance to ion migration of an electrolyte and excellent electrolyte wettability are preferable. As the separator, an insulating thin film having high ion permeability and mechanical strength is used.

The separator may generally have a pore diameter of 0.01 μm to 10 μm, and generally a thickness of 5 μm to 20 μm. As the separator, olefin-based polymers such as polypropylene; and sheets or non-woven fabrics made of glass fiber or polyethylene may be used. When a solid polymer electrolyte is used as an electrolyte, the solid polymer electrolyte may also serve as a separator.

Among the separators, specific examples of the olefin-based polymer include polyethylene, polypropylene, polyvinylidene fluoride, or a multilayer film having two or more layers thereof, and include a two-layer separator of polyethylene/polypropylene, a three-layer separator of polyethylene/polypropylene/polyethylene, a mixed multilayer film such as a three-layer separator of polypropylene/polyethylene/polypropylene.

The lithium secondary battery according to an embodiment includes a unit cell containing the cathode, the anode, and the separator disposed between the cathode and the anode.

In this case, at least one of the anode active material layer and the cathode active material layer is porous, and the lithium secondary battery may further include a gel-type polymer electrolyte, which fills the pores thereof in a state in which a crosslinkable monomer is crosslinked.

To this end, in the beginning, a unit cell stacked with the separator therebetween is assembled such that the anode and the cathode are insulated from each other, and when the unit cell is immersed in a gel precursor solution containing a crosslinkable monomer and an organic electrolyte and then cured, a gel-type polymer electrolyte, which fills pores of the porous anode material layer and/or cathode active material layer, and the separator in a state in which a crosslinkable monomer is crosslinked may be formed. In addition, a lithium secondary battery having a gel-type polymer electrolyte surrounding a unit cell may be formed.

The gel precursor solution for forming the gel-type polymer electrolyte includes a crosslinkable monomer and an organic electrolyte, and may thus be cured using heat or UV.

The crosslinkable monomer is not limited as long as it has a crosslinkable functional group in a molecule, for example, a material capable of crosslinking through heat or UV by having at least two double bonds.

For example, the crosslinkable monomer may contain at least one selected from the group consisting of diethylene glycol diacrylate (DEGDA), diethylene glycol dimethacrylate (DEGDMA), triethylene glycol diacrylate (TEGDA), triethylene glycol dimethacrylate (TEGDMA), tetraethylene glycol diacrylate (TTEGDA), glycidyl methacrylate, polyethylene glycol diacrylate (PEGDA), polyethylene glycol dimethacrylate (PEGDMA), polypropylene glycol diacrylate (PPGDA), dipropylene glycol diacrylate (DPGDA), tripropylene glycol diacrylate (TPGDA), dianol diacrylate (DDA), dianol dimethacrylate (DDMA), ethoxylated trimethylolpropane triacrylate (ETPTA), acrylate-functionalized ethylene oxide, butanediol dimethacrylate, ethoxylated neopentyl glycol diacrylate (NPEOGDA), propoxylated neopentyl glycol diacrylate (NPPOGDA), trimethylol propane triacrylate (TMPTA), trimethylol propane trimethacrylate (TMPTMA), pentaerythritol triacrylate (PETA), ethoxylated propoxylated trimethylol propane triacrylate (TMPEOTA)/(TMPPOTA), propoxylated glyceryl triacrylate, tris (2-hydroxyethyl) isocyanurate triacrylate (THEICTA), pentaerythritol tetraacrylate (PETTA), dipentaerythritol pentaacrylate (DPEPA), ditrimethylol propane tetraacrylate (DTMPTTA), diglycidyl ester, diallylsuberate, acrylamide, and divinylbenzene.

The crosslinkable monomer may have a weight average molecular weight of 200 to 2,000, or for example, 200 to 1,000, specifically 200 to 500. When the weight average molecular weight is less than 200, crosslinking point density in a molecular structure of a polymer after crosslinking is too high, and the movement of lithium salts may thus be limited, and when the weight average molecular weight is greater than 2000, crosslinking point density in a molecular structure of a polymer after crosslinking is too low, and the crosslinkable monomer may thus have a reduced electrolyte blocking ability.

With respect to a total weight of the crosslinkable monomer and the organic electrolyte, the crosslinkable monomer is contained in an amount of 5 parts by weight to 20 parts by weight, and the organic electrolyte is contained 80 parts by weight to 95 parts by weight. When the crosslinkable monomer is contained in an amount of less than 5 parts by weight, the degree of crosslinking is too low during crosslinking, and the crosslinking characteristics may not be sufficiently achieved, and the electrolytic wettability and mechanical properties may thus be poor, and when the crosslinkable monomer is contained in an amount of greater than 20 parts by weight, the internal resistance in an electrode plate increases, and that may thus cause reduction in capacity during high rate charging/discharging.

The gel precursor solution may further include a crosslinking agent, a photo initiator, etc. to facilitate crosslinking of a crosslinkable monomer. Crosslinking agents, photo initiators, etc. are not particularly limited as long as they are generally used in the art. Crosslinking agents, photo initiators, etc. may be contained in conventional ranges. For example, crosslinking agents, photo initiators, etc. may be used in the range of 1 part by weight to 5 parts by weight with respect to 100 parts by weight of the crosslinkable monomer.

The gel precursor solution may further include a polymer support for improving the strength and flexibility of a gel-type polymer electrolyte. The polymer support may include an elastomeric polymer such as polysiolxane (PSi), polyurethane (PU), and styrene-butadiene rubber (SBR). The polymer support may be used within 10 parts by weight with respect to 100 parts by weight of the crosslinkable monomer. When the polymer support is contained greater than 10 parts by weight, the gel-type polymer electrolyte may have an excessive increase in strength to cause hardening.

An organic electrolyte contained in the gel precursor solution forms a liquid electrolyte in a state of being wet-trapped in a polymer matrix after the gel-type polymer electrolyte is prepared.

The liquid electrolyte may contain a non-aqueous solvent and a lithium salt.

As the non-aqueous solvent, aprotic organic solvents such as n-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy franc, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid tryster, trimethoxymethane, dioxolane derivative, sulfolane, methyl sulfolane, 1,3-dimethyl-2-imidazolidinone, propylene carbonate derivative, tetrahydrofuran derivative, ether, methyl pyropionate, and ethyl propionate may be used.

Among the solvents above, carbonate-based solvents such as propylene carbonate, ethylene carbonate, butylene carbonate, dimethyl carbonate, and diethyl carbonate may be used.

Any lithium salts may be used as a lithium salt as long as they are commonly used in lithium secondary batteries, and as a material that is easily soluble in the non-aqueous solvent, for example, at least one material among LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂ may be used.

The concentration of the lithium salt may be, for example, 1 M to 5 M, or for example, 1 M to 2.5 M in the organic electrolyte. In the ranges above, a sufficient amount of lithium ions required for charging/discharging a lithium secondary battery may be generated.

When a unit cell including a cathode, an anode, and a separator disposed therebetween is immersed in the gel precursor solution, the gel precursor solution penetrates into the pores of the porous anode active material layer and/or cathode active material layer, and the separator, and cured together to form a gel-type polymer electrolyte, which fills the pores in a state in which a crosslinkable monomer is crosslinked. The gel-type polymer electrolyte, which fills the pores in a state in which a crosslinkable monomer is crosslinked by penetrating into the pores of the anode active material layer and/or cathode active material layer, and the separator may minimize the interfacial resistance between the anode, the cathode, and the separator, and facilitate lithium transfer.

When the unit cell in the gel precursor solution is immersed and cured, a lithium secondary battery having a gel-type polymer electrolyte surrounding the unit cell may be formed. The gel-type polymer electrolyte layer surrounding the unit cell may be present uniformly or non-uniformly.

The gel-type polymer electrolyte formed as described above may be used to keep ionic conductivity values close to that of the liquid electrolyte as well as the gel-type polymer electrolyte inside the cathode and the anode may serve to prevent leakage of a liquid electrolyte. The electrolyte is trapped in a polymer matrix of the gel-type polymer electrolyte and kept in the polymer matrix, thereby aiding the smooth movement of lithium ions. In addition, due to the excellent electrochemical properties of the polymer (−1V to 5V), an electrolyte decomposition reaction may be inhibited.

The unit cell further includes a cathode tab and an anode tab in each of the cathode and the anode, and two or more unit cells may be connected in series through the cathode tab and the anode tab. Accordingly, when series connection tabs are introduced to the unit cell including the gel-type polymer electrolyte, a cell-type lithium secondary battery having a series structure with a voltage output of 3.6 V or higher may be provided.

In the lithium secondary battery, the gel-type polymer electrolyte fills the pores of the anode and the cathode in a state in which a crosslinkable monomer is crosslinked, and the liquid electrolyte is wet-trapped in the polymer matrix of the gel-type polymer electrolyte. Therefore, there is no leakage, and electrochemical side reactions and electrolyte decomposition reactions that occur in the anode and the cathode are inhibited, and the improvement of battery characteristics and the stability of battery may be secured.

In a battery prepared using a conventional liquid electrolyte, issues of battery swelling, high temperature safety, and explosion may be raised due to liquid electrolyte leakage and electrolyte decomposition. On the other hand, the lithium secondary battery may inhibit an electrolyte decomposition reaction due to the fact that the lithium secondary battery has a lower electrochemical reaction inside a battery than the liquid electrolyte.

In addition, since the lithium secondary battery uses a polymer matrix of a gel-type polymer electrolyte as a skeleton, there is little change in the form of the electrolyte, and internal short circuits due to high temperatures while in use of battery may thus be prevented, thereby improving safety.

The application of the gel-type polymer electrolyte makes it possible to easily manufacture a lithium secondary battery usable at a high voltage, especially, employing an LTO anode.

Hereinafter, a method of manufacturing the lithium secondary battery will be described in detail.

A method of manufacturing a lithium secondary battery according to an embodiment includes:

preparing a unit cell including a cathode containing a cathode active material layer disposed on a cathode current collector, an anode including an anode active material layer disposed on an anode current collector, and a separator disposed between the cathode and the anode;

immersing the unit cell into a gel precursor solution containing a crosslinkable monomer and an organic electrolyte; and

curing the gel precursor solution to obtain a lithium secondary battery containing a gel-type polymer electrolyte.

The anode, cathode, and separator constituting the unit cell are as described above. In this case, at least one of the anode active material layer and the cathode active material layer is porous. The unit cell may be prepared by arranging the anode, the cathode, and the separator therebetween, and assembling the elements in the order of stacking, combining, and pressing.

Meanwhile, a gel precursor solution for forming a gel-type polymer electrolyte in the unit cell is prepared. The gel precursor solution for forming a gel-type polymer electrolyte contains a crosslinkable monomer and an organic electrolyte.

As described above, the crosslinkable monomer is not limited as long as it has a crosslinkable functional group in a molecule, for example, a material capable of crosslinking through heat or UV by having at least two double bonds.

For example, the crosslinkable monomer may contain at least one selected from the group consisting of diethylene glycol diacrylate (DEGDA), diethylene glycol dimethacrylate (DEGDMA), triethylene glycol diacrylate (TEGDA), triethylene glycol dimethacrylate (TEGDMA), tetraethylene glycol diacrylate (TTEGDA), glycidyl methacrylate, polyethylene glycol diacrylate (PEGDA), polyethylene glycol dimethacrylate (PEGDMA), polypropylene glycol diacrylate (PPGDA), dipropylene glycol diacrylate (DPGDA), tripropylene glycol diacrylate (TPGDA), dianol diacrylate (DDA), dianol dimethacrylate (DDMA), ethoxylated trimethylolpropane triacrylate (ETPTA), acrylate-functionalized ethylene oxide, butanediol dimethacrylate, ethoxylated neopentyl glycol diacrylate (NPEOGDA), propoxylated neopentyl glycol diacrylate (NPPOGDA), trimethylol propane triacrylate (TMPTA), trimethylol propane trimethacrylate (TMPTMA), pentaerythritol triacrylate (PETA), ethoxylated propoxylated trimethylol propane triacrylate (TMPEOTA)/(TMPPOTA), propoxylated glyceryl triacrylate, tris (2-hydroxyethyl) isocyanurate triacrylate (THEICTA), pentaerythritol tetraacrylate (PETTA), dipentaerythritol pentaacrylate (DPEPA), ditrimethylol propane tetraacrylate (DTMPTTA), diglycidyl ester, diallylsuberate, acrylamide, and divinylbenzene.

The crosslinkable monomer may have a weight average molecular weight of 200 to 2,000, or for example, 200 to 1,000, specifically 200 to 500. When the weight average molecular weight is less than 200, crosslinking point density in a molecular structure of a polymer after crosslinking is too high, and the movement of lithium salts may thus be limited, and when the weight average molecular weight is greater than 2000, crosslinking point density in a molecular structure of a polymer after crosslinking is too low, and the crosslinkable monomer may thus have a reduced electrolyte blocking ability.

With respect to a total weight of the crosslinkable monomer and the organic electrolyte, the crosslinkable monomer is contained in an amount of 5 parts by weight to 20 parts by weight, and the organic electrolyte is contained 80 parts by weight to 95 parts by weight. When the crosslinkable monomer is contained in an amount of less than 5 parts by weight, the degree of crosslinking is too low during crosslinking, and the crosslinking characteristics may not be sufficiently achieved, and the electrolytic wettability and mechanical properties may thus be poor, and when the crosslinkable monomer is contained in an amount of greater than 20 parts by weight, the internal resistance in an electrode plate increases, and that may thus cause reduction in capacity during high rate charging/discharging.

The gel precursor solution may further include a crosslinking agent, a photo initiator, etc. to facilitate crosslinking of a crosslinkable monomer. Crosslinking agent, photoinitiator, etc. may be contained in conventional ranges, and for example, crosslinking agents, photo initiators, etc. may be used in the range of 1 part by weight to 5 parts by weight with respect to 100 parts by weight of the crosslinkable monomer.

The gel precursor solution may further include a polymer support for improving the strength and flexibility of a gel-type polymer electrolyte. The polymer support may include an elastomeric polymer such as polysiolxane (PSi), polyurethane (PU), and styrene-butadiene rubber (SBR). The polymer support may be used within 10 parts by weight with respect to 100 parts by weight of the crosslinkable monomer. When the polymer support is contained greater than 10 parts by weight, the gel-type polymer electrolyte may have an excessive increase in strength to cause hardening.

The organic electrolyte may contain a non-aqueous solvent and a lithium salt.

As the non-aqueous solvent, aprotic organic solvents such as n-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydroxy franc, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid tryster, trimethoxymethane, dioxolane derivative, sulfolane, methyl sulfolane, 1,3-dimethyl-2-imidazolidinone, propylene carbonate derivative, tetrahydrofuran derivative, ether, methyl pyropionate, and ethyl propionate may be used.

Among the solvents above, non-aqueous solvents containing carbonate-based solvents such as propylene carbonate, ethylene carbonate, butylene carbonate, dimethyl carbonate, and diethyl carbonate may be used. The carbonate-based solvent has relatively excellent electrochemical stability even at a high voltage.

The lithium salt contains, for example, at least one selected from LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

The concentration of the lithium salt may be, for example, 1 M to 5 M, or for example, 1 M to 2.5 M in the organic electrolyte. In the ranges above, a sufficient amount of lithium ions required for charging/discharging a lithium secondary battery may be generated.

When a gel precursor solution containing a crosslinkable monomer and an organic electrolyte is prepared, the unit cell is immersed into the gel precursor solution. In this case, the immersing may be performed in vacuum to make sure that the gel precursor solution sufficiently penetrates into the pores of the porous anode active material layer and/or cathode active material layer, and the separator.

Thereafter, the gel precursor solution is cured to form a gel-type polymer electrolyte.

Methods of forming the gel-type polymer electrolyte may include curing using heat, UV or high energy radiation (electron beam, γ ray). The crosslinking polymerization using heat may be performed, for example, for 30 minutes to 120 minutes at 50° C. to 90° C.

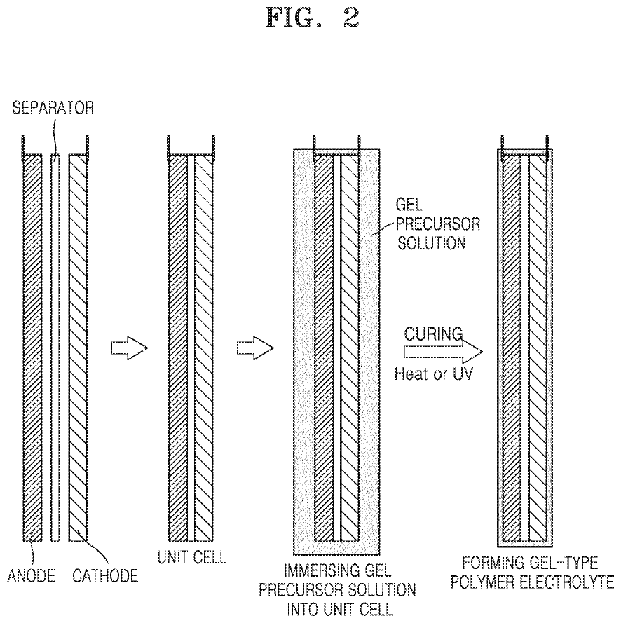

FIG. 2 is a schematic view showing a manufacturing process of a lithium secondary battery using a gel precursor solution.

The lithium secondary battery is a well fit for electric vehicles that require high capacity, high output and high temperature driving, as well as for mobile phones, portable computers, etc., and is combined with existing internal combustion engines, fuel cells, and supercapacitors, and may thus be used in hybrid vehicles. In addition, the lithium secondary battery may be applied in any cases that require high output, high voltage and high temperature driving.

Examples and Comparative Examples below are used for more detailed descriptions of example embodiments. However, Examples are for illustrative purposes only to describe technical ideas and are not intended to limit the scope of the present disclosure.

### Preparation Example 1

Polyethylene glycol dimethacrylate (PEGDMA) (Sigma-Aldrich, 302.32 g/mol) as a crosslinkable monomer, ethylene carbonate (EC), in which 1.3M LiPF₆ is dissolved, as an organic electrolyte, a mixed solvent (weight ratio of 1:1:0.5) of dimethyl carbonate (DMC) and ethyl methyl carbonate (EMC), benzoin ethyl ether (Sigma-Aldrich, 240.30 g/mol) as an initiator were used.

A gel precursor solution containing 5 parts by weight of the crosslinkable monomer and 95 parts by weight of the organic electrolyte, and 5 parts by weight of the initiator with respect to 100 parts by weight of the crosslinkable monomer was prepared.

3 g of the gel precursor solution was placed on a glass plate, covered with another prepared glass plate, and irradiated with UV of 365 nm for 8 minutes to prepare a transparent gel-type polymer electrolyte.

### Preparation Example 2

A gel-type polymer electrolyte was prepared through the same process as in Preparation Example 1, except that 10 parts by weight of the crosslinkable monomer and 90 parts by weight of the organic electrolyte were used.

### Preparation Example 3

A gel-type polymer electrolyte was prepared through the same process as in Preparation Example 1, except that 15 parts by weight of the crosslinkable monomer and 85 parts by weight of the organic electrolyte were used.

### Preparation Example 4

A gel-type polymer electrolyte was prepared through the same process as in Preparation Example 1, except that 20 parts by weight of the crosslinkable monomer and 80 parts by weight of the organic electrolyte were used.

### Evaluation Example 1

The ionic conductivity and gel properties of the gel-type polymer electrolytes prepared in Preparation Examples 1 to 4 were measured, and the results are shown in Table 1 below.

In this case, the ionic conductivity was measured at a frequency of 1 Hz to 1 MHz using a solatron 1260A Impedance/Gain-Phase Analyzer, and the gel properties were evaluated through a simple peeling test using the gel-type polymer electrolytes prepared in the same size and thickness (60 vm). “Weak” refers to a state that the gel properties may not be good enough to prepare the gel-type polymer electrolyte in the form of a film after curing, and “strong” refers to a state that the gel properties may be good enough to prepare and handle the gel-type polymer electrolyte in the form of a film.

TABLE 1

| | Preparation | Preparation | Preparation | Preparation |
|---|---|---|---|---|
| | Example 1 | Example 2 | Example 3 | Example 4 |
| Crosslinkable | 5:95 | 10:90 | 15:85 | 20:80 |
| monomer/ | | | | |
| organic | | | | |
| electrolyte | | | | |
| Ion | >10⁻³ S/cm | >10⁻³ S/cm | >10⁻³ S/cm | >10⁻³ S/cm |
| conductivity | | | | |
| Gel properties | Weak | Weak | Good | Strong |

As shown in Table 1, it is confirmed that the prepared gel-type polymer electrolyte had an ionic conductivity of 10⁻³ S/cm or greater, which is applicable to a battery, and leakage and safety of the electrolyte were secured.

### Example 1

A lithium secondary battery was manufactured as follows using the gel precursor solution used in Preparation Example 3 among Preparation Examples 1 to 4.

A 3 cm×4 cm LTO cathode, a 3.3 cm×4.3 cm PE separator, and a 3 cm×4 cm LCO anode were stacked to form one unit cell. LTO430 HL and LCO1120 from Grinergy were used as an LTO electrode and an LCO electrode.

8 ml of the gel precursor solution used in Preparation Example 3 for the unit cell was injected using a disposable pipette, and then the injected was placed on a hot plate at 70° C. and thermally crosslinked to form a gel-type polymer electrolyte, thereby obtaining a pouch-type lithium secondary battery.

### Comparative Example 1

In the unit cell in which the LTO anode, the PE separator, and the LCO cathode used in Example 1 were stacked, a liquid electrolyte in which 1M LiPF₆ was dissolved in a mixed solvent (weight ratio of 1:1:0.5) of EMC (ethylene carbonate):DMC (dimethyl carbonate):EMC (ethyl methyl carbonate) was injected to prepare a lithium secondary battery.

### Evaluation Example 2: Evaluation of High-Temperature Discharge Characteristics at 60° C. and 80° C.

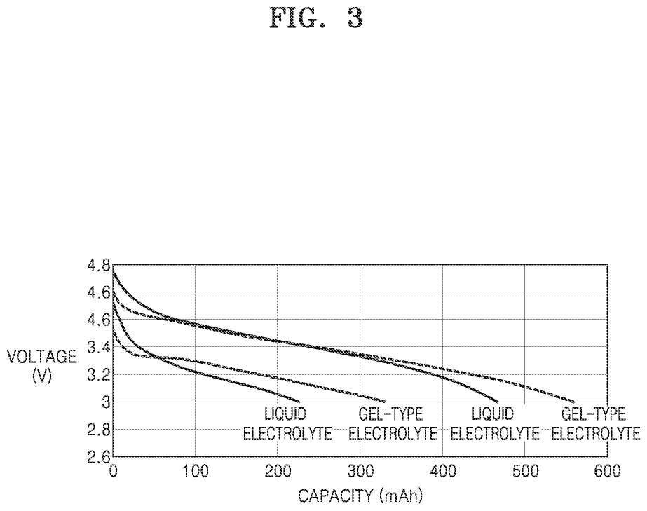

The 60° C. and 80° C. high-temperature discharge characteristics of the lithium secondary batteries of Example 1 and Comparative Example 1 were evaluated as follows, and the results are shown in FIG. 3.

The lithium secondary batteries of Example 1 and Comparative Example 1 were placed in the same chamber (explosion-proof oven) and left for one hour, and then discharge characteristics of the lithium secondary batteries were evaluated at 60° C. and 80° C., respectively. Discharge conditions are as follows.
Nominal Capacity: 750 mAh
Test method: Charge—CC/CV 0.7 C/4.2V_20 mAh cut-off

Discharge—CC 1 C/3V cut-off

In FIG. 3, a short graph is results of the evaluation at 80° C., and a long graph is results of the evaluation at 60° C. As shown in FIG. 3, at both temperatures, the lithium secondary battery using the gel-type polymer electrolyte of Example 1 showed better results in the discharge characteristics than the lithium secondary battery using the liquid electrolyte of Comparative Example 1. This is believed to be due to the fact that the cell using the liquid electrolyte had reduced ionic conductivity because of the evaporation of DMC and EMC at high temperatures, but the gel-type polymer electrolyte had relatively little evaporation of the electrolyte and little change in the ionic conductivity.

### Evaluation Example 3: Evaluation of Battery Swelling Characteristics

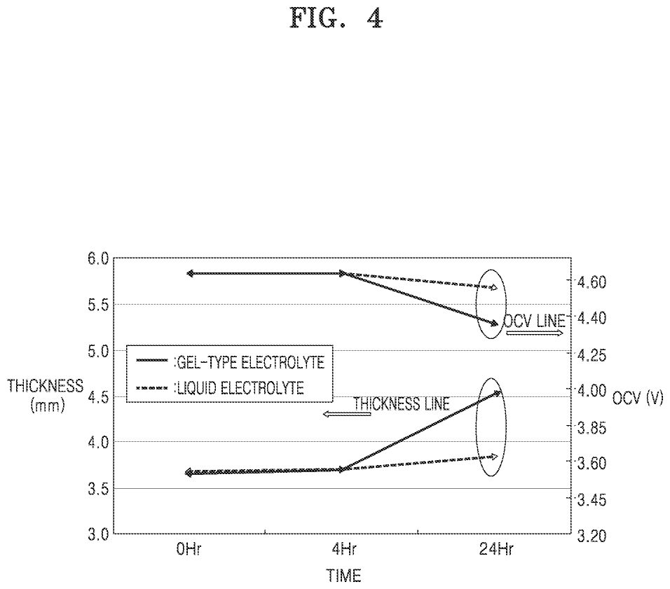

In order to evaluate the swelling characteristics of the lithium secondary batteries of Example 1 and Comparative Example 1, the lithium secondary batteries of Example 1 and Comparative Example 1 were respectively placed in an explosion-proof oven at 80° C. and were measured in 0 CV and thickness after 0 hours, 4 hours, and 24 hours, and the results are shown in FIG. 4.

As shown in FIG. 4, the lithium secondary battery of Comparative Example 1 using the liquid electrolyte kept the same OCV and thickness in the beginning, but over time, at a high temperature, the lithium secondary battery of Comparative Example 1 exhibited increased swelling and decreased OCV, whereas the lithium secondary battery of Example 1 to which the gel-type polymer electrolyte was applied exhibited slightly decreased swelling and OCV characteristics. It is believed from the results that the gel-type polymer electrolyte more effectively protects the electrolyte in the polymer matrix, and is superior in safety characteristics to the existing liquid electrolyte at a high temperature.

Although preferred embodiments of the present disclosure have been described with reference to drawings and examples, this is only for illustrative purposes, and therefore, those skilled in the art will appreciate that various modifications and other equivalent embodiments may be made therein. Hence, the protective scope of the present disclosure shall be determined by the scope of the appended claims.

1. A lithium secondary battery comprising a unit cell including:
a cathode including a cathode active material layer disposed on a cathode current collector;
an anode including an anode active material layer disposed on an anode current collector; and
a separator disposed between the cathode and the anode,
wherein at least one of the anode active material layer and the cathode active material layer is porous, and the lithium secondary battery further comprises a gel-type polymer electrolyte, which fills the pores thereof in a state in which a crosslinkable monomer is crosslinked.

2. The lithium secondary battery of claim 1, wherein the anode active material layer is porous, and the lithium secondary battery further comprising a gel-type polymer electrolyte, which fills the pores of the porous anode active material layer in a state in which a crosslinkable monomer is crosslinked.

3. The lithium secondary battery of claim 1, wherein the anode active material layer comprises lithium titanium oxide (LTO).

4. The lithium secondary battery of claim 1, wherein the crosslinkable monomer contains at least one selected from the group consisting of diethylene glycol diacrylate (DEGDA), diethylene glycol dimethacrylate (DEGDMA), triethylene glycol diacrylate (TEGDA), triethylene glycol dimethacrylate (TEGDMA), tetraethylene glycol diacrylate (TTEGDA), glycidyl methacrylate, polyethylene glycol diacrylate (PEGDA), polyethylene glycol dimethacrylate (PEGDMA), polypropylene glycol diacrylate (PPGDA), dipropylene glycol diacrylate (DPGDA), tripropylene glycol diacrylate (TPGDA), dianol diacrylate (DDA), dianol dimethacrylate (DDMA), ethoxylated trimethylolpropane triacrylate (ETPTA), acrylate-functionalized ethylene oxide, butanediol dimethacrylate, ethoxylated neopentyl glycol diacrylate (NPEOGDA), propoxylated neopentyl glycol diacrylate (NPPOGDA), trimethylol propane triacrylate (TMPTA), trimethylol propane trimethacrylate (TMPTMA), pentaerythritol triacrylate (PETA), ethoxylated propoxylated trimethylol propane triacrylate (TMPEOTA)/(TMPPOTA), propoxylated glyceryl triacrylate, tris (2-hydroxyethyl) isocyanurate triacrylate (THEICTA), pentaerythritol tetraacrylate (PETTA), dipentaerythritol pentaacrylate (DPEPA), ditrimethylol propane tetraacrylate (DTMPTTA), diglycidyl ester, diallylsuberate, acrylamide, and divinylbenzene.

5. The lithium secondary battery of claim 1, wherein the crosslinkable monomer is ion conductive.

6. The lithium secondary battery of claim 1, wherein the gel-type polymer electrolyte further comprises a liquid electrolyte.

7. The lithium secondary battery of claim 6, wherein the liquid electrolyte contains a non-aqueous solvent and a lithium salt.

8. The lithium secondary battery of claim 7, wherein the non-aqueous solvent comprises a carbonate-based solvent.

9. The lithium secondary battery of claim 7, wherein the lithium salt contains at least one selected from LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

10. The lithium secondary battery of claim 1,
wherein the gel-type polymer electrolyte further comprises a polymer support,
the polymer support containing an elastomeric polymer.

11. The lithium secondary battery of claim 1, further comprising a gel-type polymer electrolyte layer covering an outer surface of the unit cell.

12. The lithium secondary battery of claim 1,
wherein the cathode and the anode further comprise a cathode tab and an anode tab, respectively; and
the lithium secondary battery comprises two or more unit cells, the unit cells being connected in series by the cathode tab and the anode tab.

13. A method of manufacturing a lithium secondary battery, the method comprising:
preparing a unit cell including a cathode containing a cathode active material layer disposed on a cathode current collector, an anode containing an anode active material layer disposed on an anode current collector, and a separator disposed between the cathode and the anode;
immersing the unit cell into a gel precursor solution containing a crosslinkable monomer and an organic electrolyte; and
curing the gel precursor solution to obtain a lithium secondary battery containing a gel-type polymer electrolyte.

14. The method of claim 13, wherein the crosslinkable monomer contains at least one selected from the group consisting of diethylene glycol diacrylate (DEGDA), diethylene glycol dimethacrylate (DEGDMA), triethylene glycol diacrylate (TEGDA), triethylene glycol dimethacrylate (TEGDMA), tetraethylene glycol diacrylate (TTEGDA), glycidyl methacrylate, polyethylene glycol diacrylate (PEGDA), polyethylene glycol dimethacrylate (PEGDMA), polypropylene glycol diacrylate (PPGDA), dipropylene glycol diacrylate (DPGDA), tripropylene glycol diacrylate (TPGDA), dianol diacrylate (DDA), dianol dimethacrylate (DDMA), ethoxylated trimethylolpropane triacrylate (ETPTA), acrylate-functionalized ethylene oxide, butanediol dimethacrylate, ethoxylated neopentyl glycol diacrylate (NPEOGDA), propoxylated neopentyl glycol diacrylate (NPPOGDA), trimethylol propane triacrylate (TMPTA), trimethylol propane trimethacrylate (TMPTMA), pentaerythritol triacrylate (P ETA), ethoxylated propoxylated trimethylol propane triacrylate (TMPEOTA)/(TMPPOTA), propoxylated glyceryl triacrylate, tris (2-hydroxyethyl) isocyanurate triacrylate (THEICTA), pentaerythritol tetraacrylate (PETTA), dipentaerythritol pentaacrylate (DPEPA), ditrimethylol propane tetraacrylate (DTMPTTA), diglycidyl ester, diallylsuberate, acrylamide, and divinylbenzene.

15. The method of claim 13, wherein, with respect to a total weight of the crosslinkable monomer and the organic electrolyte, the crosslinkable monomer is contained in an amount of 5 parts by weight to 20 parts by weight, and the organic electrolyte is contained 80 parts by weight to 95 parts by weight.

16. The method of claim 13, wherein the organic electrolyte contains a non-aqueous solvent and a lithium salt.

17. The method of claim 13, wherein the gel precursor solution further comprises a polymer support, the polymeric support containing an elastomeric polymer.

18. The method of claim 13, wherein the immersing is performed in vacuum.

19. The method of claim 13, wherein the curing is performed using heat, UV or high energy radiation.

20. The method of claim 13, wherein the curing is performed for 30 minutes to 120 minutes at 50° C. to 90° C. using heat.
